(19) United States
(12) Patent Application Publication
(10) Pub. No.: US 2018/0042247 A1
(43) Pub. Date: Feb. 15, 2018

(54) DEVICE FOR CLEANING AND FOR PROCESSING THE RECTUM AND PELVIS OF SLAUGHTERED PIGS AND OPERATING METHOD OF SAID DEVICE

(71) Applicant: INNOVATIVE FOOD ROBOTICS-BANSS & AIRA, S.L., Cardona (ES)

(72) Inventor: Francisco Javier Jané López, Cardona (ES)

(21) Appl. No.: 15/559,735

(22) PCT Filed: Dec. 17, 2015
(86) PCT No.: PCT/ES2015/070921

§ 371 Date: Sep. 19, 2017

(30) Foreign Application Priority Data
Mar. 30, 2015 (ES) P201530426

(51) Int. Cl. A22B 5/00; B08B 15/04; B08B 3/02

(52) U.S. Cl. CPC A22B 5/0005; A22B 5/0041; A22B 5/0082; B08B 3/02; B08B 15/04; A22B 2005/0011

(57) ABSTRACT

The invention relates to a device for cleaning and processing the rectum and pelvis of slaughtered pigs, that is mainly mechanical in nature, and its operating method and that it solves the problem of the cleaning and disinfection operations of these devices, basically of the blades and the mandrel which are inserted into the animal's rectum, this invention carries out these operations in a single operation, which allows it to successively in about 2 to 3 seconds enter the animal's rectum, cut it out and make an incision in the animal's pelvis and then simultaneously clean and sterilize by incorporating into the device a semi-enclosed chamber in which this cleaning takes place.

### OBJECT OF THE INVENTION

More specifically, the invention relates to a device for cleaning and processing the rectum and pelvis of slaughtered pigs and the operating method of the device the arrangement of which is mainly mechanical in nature, which allows it, in a period of about 2 to 3 seconds, to enter the animal's rectum, cut it out, create an incision in the animal's pelvis and, simultaneously clean and sterilize itself, as the device incorporates a semi-enclosed chamber in which this process can take place.

### STATE OF THE ART

Devices for the cleaning and processing of the rectum of slaughtered pigs are available on the market and they can, therefore, be considered as the state of the art, this cleaning usually takes place on the continuous chains commonly found in all industrial slaughterhouses, for example, that described and claimed in European Patent No. 1,115,292.

Said patent consists of an apparatus with a suction mechanism for a disinfectant substance, supplied to a cavity occupied by a cylindrical blade, separated from the mechanism in order to establish the negative pressure to empty a part of the rectum and comprising an arrangement for establishing an additional negative pressure in said cavity.

Another of the references contained in the state of the art is European Patent No. 457,409 which describes and claims a device for separating the pubis from the body of a slaughtered animal, specifically that of a pig comprising a positioning element, a rotating cylindrical cutter and a blade-like cutting disc that are combined in a functional unit that can be moved in its entirety from the carcass.

Another of the references found is European Patent No. 258,939, the object of which is a piece of equipment for cutting and opening the body of a dead animal, mainly the pubis of the carcass of the dead animal, an element for positioning the slaughtered animal is claimed, an initial cutting element and a second cutting element, together with a sensor coupled to the second cutting element for locating the pubis, all combined in a functional unit.

In all the embodiments of these references the cleaning of the parts that make up the devices can clearly be improved, since in most cases this is carried out automatically by submerging the cutting head in a tank containing water and disinfectant, which, although it cleans automatically, does not ensure the cleaning.

### PURPOSE OF THE INVENTION

To improve the cutting of the rectum and sectioning of the pelvis and the subsequent cleaning of the components used for this purpose, all without delaying the movement of the continuous chains that industrial slaughterhouses are equipped with.

### DESCRIPTION OF THE INVENTION

Health in the field of human food products requires solutions to be found that improve the state of the art and, more specifically in this case, requires the creation of ways to ensure the perfect handling of animals, preferably but not exclusively pigs, to prevent these solutions from contaminating the entire process of cutting up the animal, as well as certain shortcomings that force the withdrawal of some units, where a bad cut to the pig can mean that some parts must be discarded, with the consequent economic losses.

Within the cutting process, and in one of the initial stages, the rectum of a slaughtered pig must be removed, first by cutting it and then by removing it, evacuating the deposits it contains, without this resulting in a loss of hygiene or the contamination of the other parts of the animal and, simultaneously, or subsequently, an incision has to be made in the pelvis that allows the separation of the hind quarters.

The present invention consists of, that in an orderly manner after cutting and removing the rectum and evacuating the deposits it contains, the components used in such operations are cleaned effectively, including the blade and the mandrel introduced in a programmed way within the animal's rectum.

The cleaning of the device is possible as the design allows for these components, comprising a mandrel and some cutting knives, to remain for a period of some 2 to 3 seconds inside a cavity formed by the closing together of two articulated valves, so that the cavity is formed when one valve drops onto the other, pressurized water or disinfectant or a combination of them is introduced into the interior through an input conduit so as to clean everything that is inside the cavity mainly the mandrel and the cutting blades, the fluids are then evacuated along with particles of debris collected by the cleaning through an output provided in the lower valve.

These valves, in addition to being designed so that their edges are facing each other when the upper valve drops over the lower one forming a semi-enclosed chamber, also have parts that allow them to move from a position on the far left of the device, where they are completely separate, to the extreme right where they together, one over the other.

These components comprise a set of levers that, at one end, are attached to the body of the valves, while at the opposite end they are attached to supports or slides that push the articulated levers using connecting rods, one end of which is joined to the levers, while at the other end these rods are attached to the head of a stem that moves from right to left and vice versa, through the action of a pneumatic or hydraulic cylinder on the stem.

The action of opening and closing the cavity, which involves the separation of the valves and their coming together respectively, takes place in combination with the action of a mandrel that slides to the right and left and vice versa, as well as the extension of the mandrel in conjunction with it, along with a knife that also describes the same movement and which produces an incision to the animal's hind quarters breaking the pelvis, without cutting the thighs or hams which are handled separately once the pig has been cut apart, if these parts were cut they could not then be used with the consequent economic loss.

Other details and characteristics will become apparent in the description provided below, in which reference is made to the figures in which a practical embodiment of the invention is shown by way of illustration that is not limiting, it can be carried out with all kinds of materials where they are appropriate.

### DESCRIPTION OF THE FIGURES

The following is a list of the different parts of the invention, which are located in the following figures using the numbers listed below: (10) device, (11) upper valve, (12) lower valve, (13) fluid output, (14) lower base, (15) set of levers, (16-17) levers, (18) blade, (19) blade holder, (20) mandrel, (20b) lateral surface of the mandrel, (21) extension, (22) pneumatic and/or hydraulic cylinder, (23) support rod, (24) stem, (25) head, (26) joints, (27) connecting rods, (28) semi-enclosed cavity, (29) joints, (30) screws, (31) knife support, (32) slide, (33) bench, (34) mounting plate support, (35) robot, (36) tubular element, (37) arm, (38) appendages, (39) guide rail, (40) plates, (41) water input conduit, (42) circular blade.

FIG. 1 is a side elevation view of the device (10), in which it is possible to see the upper and lower valves (11-12) articulated by the levers (16-17).

FIG. 2 is a side elevation view of the device (10) showing the valves (11-12), displaced to the right by the movement of the levers (16-17) due to the action of the pneumatic cylinder (22) on the connecting rods (27) and on these levers (16-17), covering the mandrel (20) and the extension (21) with the valves (11-12) forming the semi-enclosed cavity (28).

FIG. 3 is a partial side elevation view of the device (10) with the parts that allow the movement of the valves (11-12), this occurs as they are arranged at one end of the levers (16-17), their rotation with respect to the support plates (23) with the aid of the joints (26) and (29) connected to the connecting rods (27) and these rods connection to the head (25) of the stem (24) of the pneumatic cylinder (22).

FIG. 4 is a similar view to FIG. 3 in which the valves (11-12) are withdrawn to the left of the device (10).

FIG. 5 is a perspective view of the device (10) mounted on a bench (33) and the latter to a plate support (34) mounted on an arm (37), which attaches to a robot (35) not detailed in this figure.

### DESCRIPTION OF AN EMBODIMENT OF THE INVENTION

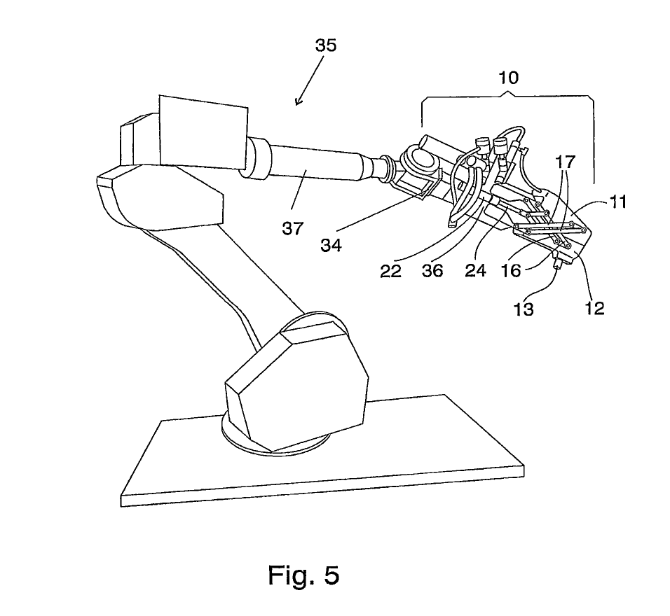

In one of the preferred embodiments of the invention and as can be seen in FIG. 5 an exemplary device (10) is available on a conventional robot (35) and, via a support plate (34), mounted on an arm (37) of the robot (35), for which it is attached to a tubular element (36) perpendicular to said support plate (34), which incorporates the pneumatic and/or hydraulic cylinder (22) that operates the levers (16-17), attaching the levers (16-17) to the support plates (23) that are moved to either side of the tubular element (36) with the aid of the appendages (38) that form a single piece with the support plates (23) as described below.

The core of the invention is the device (10), although to facilitate the understanding of the invention from the perspective of FIG. 5 only part of it has been reproduced, based on a robot (35) and a robot arm (37), the robot (35) is completely conventional and, as indicated previously the device (10) is mounted on the robot (35).

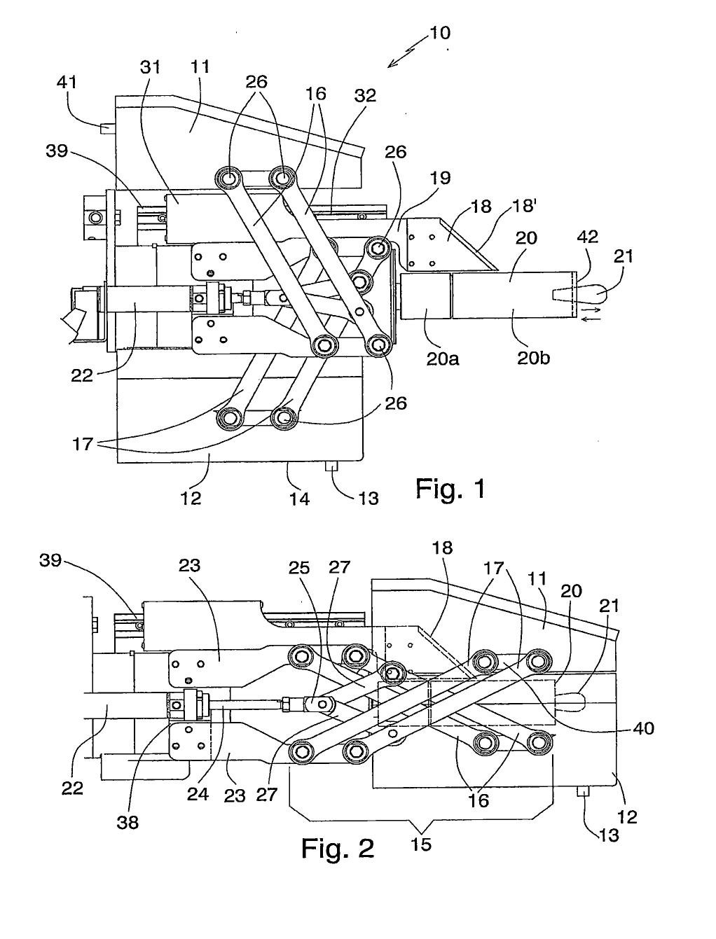

As the device (10) is asymmetrical it is reproduced in FIGS. 1-4, for greater precision in the description, such that in FIG. 1 the two valves (11-12) appear in the extreme left position, exposing the mandrel (20) which emerges from the end of the tubular element (36).

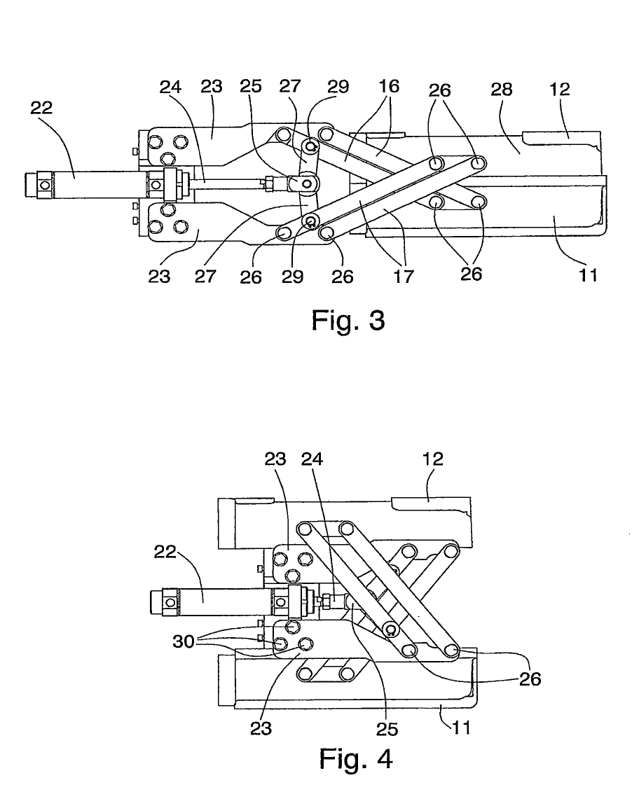

These valves (11-12) move from the position indicated in FIG. 1, to a position to the extreme right represented in FIG. 3, it being possible for these valves (11-12) to make this movement from left to right and vice versa by the combined action of a set of levers (15).

The aforementioned set of levers (15) as can be seen in FIG. 2 includes the levers (16-17) themselves, whose ends are attached at one end to the valves (11-12), reinforcing the valves (11-12) with plates (40) and the opposite ends are attached to support plates (23) and connecting rods (27), which at one end join the levers (16-17) and at the other join the head (25) of a shaft (24) of a pneumatic and/or hydraulic cylinder (22), where the action of pushing the stem (24) forces the connecting rods (27) to push or pull the levers (16-17), with the aid of the corresponding joints (26).

The extension (21) extends out of one end of the mandrel (20) allowing the passage of air and water within it to place the mandrel (20) and the extension (21) into the working position inside the animal's rectum, which surrounds the lateral surface (20b) of the mandrel (20) so that it is possible to cut it out due to the action of a blade (18) mounted on the blade holder (19) and this blade holder (19) is attached to the knife support (31), which moves left and right along the guide rail (39) as can be seen in FIGS. 1 and 2.

As a characteristic of the invention, the function of the valves (11-12) when folded one over the other, see FIGS. 3 and 5, is to create a semi-enclosed cavity into which water and air is injected by the input conduit (41) in the upper valve (11) for cleaning both the blades (18) and (42) as well as the mandrel (20) and its extension (21) when they have finished their work and are in the interior of this semi-enclosed cavity, which takes advantage of the time that passes between the cutting of one animal and the next on the continuous chain, as part of this cleaning the dirty water discharges through the fluid output (13) at the bottom of the bottom valve (12), as a result the mandrel (20), the extension (21) and the blades (18) and (42) do not come into contact with dirty water and they will, therefore, not contaminate the next animal.

The operating cycle of the device (10) begins when the already slaughtered animal, which is hanging by its hind quarters from the continuous chain, is placed by appropriately in front of the device (10) and remains still for around 2 to 3 seconds, when the following movements take place.
The extension (21) and mandrel (20) are introduced through the animal's rectum to a predetermined depth, leaving the blade 18 facing the animal's hind quarters.
The mandrel (20) extends from the left to the right inside the rectum and removes it with the help of a circular blade (42), located at the right end of the mandrel (20) evacuating the pieces of the rectum and the feces contained therein through the duct provided in the extension (21).
The blade (18) moves from left to right due to the action of the knife support (31), which moves along the guide rail (39) and produces an incision in the central part of the pelvis.
The blade (18) moves back from right to left due to the action of the knife support (31) guided by the guide rail (39), along with the mandrel (20) and the extension (21), the valves (11-12) are closed forming a semi-enclosed cavity (28) and simultaneously water and air enter through the input conduit (41), when inside the semi-enclosed cavity (28) this water cleans the blades (18) and (42) the mandrel (20) and the extension (21), the water and dirt leave by the output (13).

The present invention is sufficiently described in correlation with the attached figures, it is easy to understand that any detailed modifications could be made to it that may be deemed suitable, provided that the invention is not disturbed, which is summarized in the following claims.

1. A device for cleaning and processing the rectum and pelvis of a slaughtered pig that is adapted for attachment to an arm of a robot, the arm having a function that includes the partial cutting of the rectum and an incision in the pelvis of the animal, carried out by a first blade in combination with a mandrel with a circular blade and an extension, wherein the device is attached to a tubular element that is perpendicular to a mounting plate support mounted on the arm of the robot, and the mounting plate support incorporates a pneumatic and/or hydraulic cylinder, and further wherein the device comprises:
articulated upper and lower valves;
levers attached at one end to a support plates located to the right and left of the tubular element, and at the other end to the articulated upper and lower valves; and
connecting rods that at one end are connected to the levers and at the opposite ends are attached to the head of the stem of a pneumatic and/or hydraulic cylinder,
and further wherein the articulated upper and lower valves are adapted to drop down against each other, creating a semi-enclosed cavity where the first blade and the circular blade as well as the mandrel and its extension are inside.

2. The device of claim 1, wherein the upper valve comprises an input and the lower valve comprises an output located at its bottom.

3. The device of claim 1, wherein the circular blade and the extension extend from a lateral surface of the mandrel, and both the mandrel and the extension are adapted to move into a working position within the animal's rectum.

4. The device of claim 1, wherein the first blade is flat and has a cutting edge.

5. A method for cleaning and processing the rectum and pelvis of a slaughtered pig, the method comprising:
providing the device for cleaning and processing the rectum and pelvis of a slaughtered pig of claim 1;
introducing the extension and mandrel of the device of claim 1 through the animal's rectum to a predetermined depth oriented such that the first blade faces the animal's hind quarters;
extending the mandrel from left to right inside the animal's rectum and removing it with the help of a circular blade located at the right end of the mandrel, evacuating pieces of the rectum and the feces contained therein through a duct provided in the extension;
moving the first blade from left to right via action of a knife support moving along a guide rail, thereby producing an incision in the central part of the pelvis; and
moving the first blade back from right to left via action of the knife support guided by the guide rail along with the mandrel and the extension, thereby closing the valves and forming a semi-enclosed cavity whereby water, disinfectant and air enter the semi-enclosed cavity via an input conduit to clean the first and circular blades, the mandrel, and the extension, with the water, disinfectant, and debris being removed via an output.

6. The method of claim 5, wherein the upper valve comprises an input and the lower valve comprises an output located at its bottom.

7. The method of claim 5, wherein the circular blade and the extension extend from a lateral surface of the mandrel, and both the mandrel and the extension are adapted to move into a working position within the animal's rectum.

8. The method of claim 5, wherein the first blade is flat and has a cutting edge.
